(19) United States
(12) Patent Application Publication
(10) Pub. No.: US 2021/0179288 A1
(43) Pub. Date: Jun. 17, 2021

(54) Airplane Cockpit Tablet Mount

(71) Applicant: JACK M. JOHNSON, Wichita, KS (US)

(72) Inventor: JACK M. JOHNSON, Wichita, KS (US)

(21) Appl. No.: 16/711,145

(22) Filed: Dec. 11, 2019

(51) Int. Cl. B64D 43/00; G06F 1/16; B64D 45/00

(52) U.S. Cl. CPC B64D 43/00; B64D 2045/0075; B64D 45/00; G06F 1/1626

(57) ABSTRACT

An airplane cockpit tablet mount used to allow for the mounting of a tablet computer into the instrument panel of the aircraft. The tablet mount has means for rotating the tablet computer toward the pilot at an angle selected by the pilot during operation. The tablet mount allows for ease of locking the tablet into the mount and easily removing the tablet.

### STATEMENT OF PRIORITY

Not applicable

### BACKGROUND

### Field

The present invention relates to aircraft instrument mounting devices.

### Background

The first glass cockpit systems were utilized in large commercial aircraft to assist pilots with the navigation of the aircraft. Glass cockpit systems feature electronic screens to display flight information that has heretofore been displayed on analog dials, instruments or paper. The use of electronic screens allows for the display of a wide range of information in one place, with the pilot selecting the information to be displayed on the screen. Rather than solely relying on clipboards and kneeboards to store navigational information, glass cockpits allow this information to be displayed in a consistent location on the instrument panel. In some cases, the glass cockpit system improved the efficiency of cockpit operations so much so that the third crewmember position has been eliminated in some aircraft significantly cutting costs for airlines.

The ease of use and efficiency of glass cockpit systems eventually led to the pilots of smaller aircraft seeking to retrofit their aircraft with glass cockpit systems. While commercial airliners typically have a co-pilot who can assist the pilot of the aircraft, pilots of smaller General Aviation (GA) aircraft typically fly without such assistance. As a result, there is much for the pilots of smaller aircraft to gain from the ease of use and flexibility of glass cockpit systems. In fact, the Federal Aviation Administration now recommends the use of electronic systems to display flight information.

However, pilots of smaller aircraft are often put off by the substantial expense required to install a glass cockpit system, which can exceed twenty thousand dollars. As a result, some pilots have turned to using tablet computers such as the Apple® iPad®, Windows® Surface®, or other similar devices to display flight information in the cockpit. These devices can run applications for the display of flight information along with other relevant information for the pilot. The ability of small aircraft to have access through electronic means to a broad array of flight information, such as current navigational charts, weather data and GPS (“Global Positioning System”), allows for greater flight safety by reducing the risk of navigational errors.

The use of tablet computers to display flight information could save the pilot thousands of dollars. However, these devices are an additional piece of equipment for which there is no ordinary accommodation in the instrument panels of smaller and older aircraft. Consequently, many pilots simply store the tablet computer on their leg, on the floor, or on a seat while flying the aircraft. Unfortunately, turbulence during flight creates a strong possibility that the device will fall out of reach of the pilot, rendering it unusable for the remainder of the flight. The untimely loss of important flight information, particularly when flying under instrument flight rules (IFR) creates a significant safety concern.

Some pilots have sought to alleviate the awkwardness of using and handling the tablet along with their concern for it becoming loose in the cockpit by employing a mount to hold the tablet in place. The mounts currently available on the market tend to be either cumbersome claw-type devices that extend several inches from the instrument panel, which may cause an obstruction of view and reach of the pilot or panel-mount devices that hold the computer in a fixed position, restricting both proper viewing angle and input-operations for the tablet. However, some panel mounted devices cannot be added to an angled instrument panel as is found in some aircraft models such as the Cessna 182, and neither of these styles offers an ideal method of locking the tablet into its mount. These limitations discourage many pilots from using these earlier mounts and cause them to revert to storing the device in ways previously described.

### SUMMARY

The present disclosure provides a device that may be used to mount a tablet computer to the instrument panel in the cockpit of an airplane. The provided device will provide owners of older aircraft with the ability to upgrade their aircraft with modern navigation and flight planning systems without the expense of a typical “glass cockpit” system.

In some embodiments, the devise allows for the tablet computer to be mounted into an instrument panel of many types of small aircraft. In one specific embodiment, the device is shaped to fit within the contour of the Cessna 182 aircraft instrument panel. The inability to mount the tablet computer into the instrument panel may result in the tablet computer becoming dislodged or an obstruction to the pilot's reach while operating the aircraft.

Some embodiments of the device allow for the mount to incorporate a tablet computer such as an Apple iPad®, Microsoft Surface®, or other similar device which may be removed from the mount in lieu of an integrated computer such as the typical “glass cockpit” system. One advantage of such a system includes allowing the creation of a flight plan or entering other navigation data on the tablet computer before arrival at the airport, bringing the tablet computer onto the aircraft, and mounting it for use during flight.

In some embodiments, the devise allows for the user to easily mount or remove the tablet computer by allowing for easy access to the rear of the mount as facilitated by its rotation. Furthermore, removal of the tablet computer is accomplished by a lever-type latch, which when actuated, permits removal of the tablet computer from the mount.

Additionally, the device may allow for a better view of the tablet and reduces glare during flight by allowing the tablet computer to rotate toward the pilot. The selectable angle of rotation of the tablet toward the pilot also allows for easier computer input operations. By allowing rotation, the time spent attempting to view or input information into the navigation system is reduced that lowering the amount of time the pilot's eyes are away from the other instruments of the aircraft. As a result, the rotation of the tablet computer toward the pilot may improve flight safety for those who use a tablet computer during flight.

As used herein, the term “approximately,” “approximate,” or “about” when used to describe an angle is intended to mean with the standard error of the measuring device or within ±5° whichever is larger.

### BRIEF DESCRIPTION OF THE DRAWINGS

FIG. 1 illustrates a front perspective view of the embodiment in a closed position.

FIG. 2 illustrates a front perspective view of the embodiment in a closed position.

FIG. 3 illustrates a front perspective view of the embodiment in an open position.

FIG. 4 illustrates a front perspective view of the embodiment in an open position.

FIG. 5 illustrates a front elevation view of the embodiment in a closed position.

FIG. 6 illustrates a rear perspective view of the embodiment in a closed position.

FIG. 7 illustrates a rear perspective view of the mount in a closed position.

FIG. 8 illustrates a rear perspective view of the embodiment in an open position.

FIG. 9 illustrates a rear perspective view of the embodiment in an open position.

FIG. 10 illustrates a side elevation view of the embodiment in a closed position.

FIG. 11 illustrates a side elevation view of the embodiment in an open position.

FIG. 12 illustrates a plan view of the embodiment in a closed position.

FIG. 13 illustrates a plan view of the embodiment in an open position.

FIG. 14 illustrates a perspective view of an alternative embodiment in a closed position.

FIG. 15 illustrates a perspective view of an alternative embodiment in an open position.

FIG. 16 illustrates a plan view of an alternative embodiment in a closed position.

FIG. 17 illustrates a plan view of an alternative embodiment in an open position.

FIG. 18 illustrates an example of an embodiment mounted to the instrument panel of an airplane.

### DETAILED DESCRIPTION

The present disclosure relates to a devise which may be used as an instrument panel mount for tablet computers. The device mounts the tablet computer in place and allow for the pilot to easily lock the tablet computer in place but then subsequently remove the device from the mount. Additionally, the integration of the device into the instrument panel of the aircraft prevents obstruction of the pilot's reach or view in the cockpit. Furthermore, the device may be rotated at any angle up to approximately 30-degrees such that the tablet computer is more conveniently located for the pilot to use, which reduces glare and improves the pilot's view of the displayed flight information.

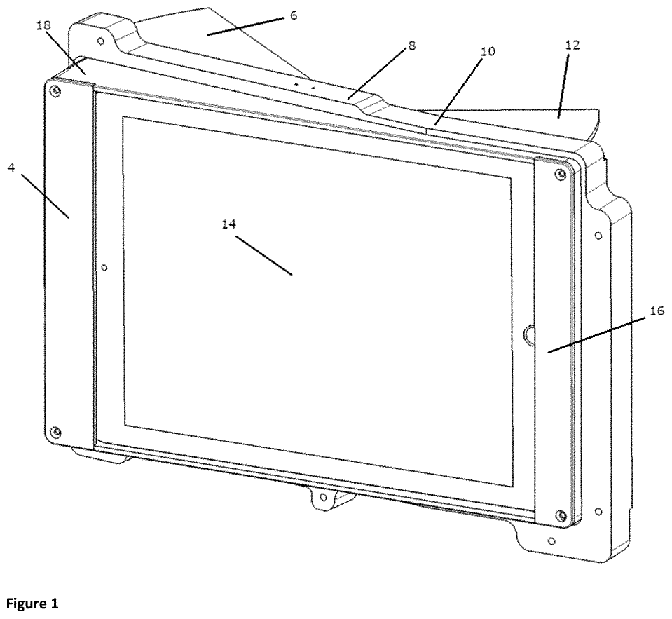

One embodiment of the aircraft cockpit tablet mount shown in FIG. 1 is specifically for a Cessna 182 aircraft and is identified generally by the reference numeral 2. A variation of this particular design is used for other aircraft makes and models. The aircraft cockpit tablet mount is made up of two primary components. The first of these components is panel mounting frame 8. Said panel mounting frame 8 attaches to the instrument panel of the aircraft to hold the entire embodiment in place. The second primary component of an embodiment of said aircraft cockpit tablet mount is tablet mounting frame 18. Tablet mounting frame 18 is housed inside said panel mounting frame 8. Said tablet mounting frame holds a tablet computer in place, here illustrated by tablet 14.

Said panel mounting frame 8 further comprises a rear housing 6. Said rear housing 6 houses said tablet mounting frame 18 when said tablet mounting frame is rotated toward the operator of the aircraft. The interface between said rear housing 6 and said tablet mounting frame 18 prevents said tablet mounting frame from rotating beyond a usable angle for the operator of the aircraft.

The right side of said tablet mounting frame 18 further comprises right upper close-out fin 12 and right lower close-out fin 32, which are located in the top right and bottom right corners of said tablet mounting frame 18 respectively. Said right upper close-out fin 12 and right lower close-out fin 32 extend from the medial portion of the top and bottom of the rear of said tablet mounting frame 18.

Said tablet mounting frame 18 further comprises left bezel 4 and right bezel 16 which are located on the left and right sides of the front of said tablet mounting frame 18 respectively. Said left bezel 4 and right bezel 16 function to hold a tablet in place when the retaining latch is engaged, as illustrated by said tablet 14.

The panel mounting frame 8 features a Cessna 182 mount angle 10 located toward the right end of said panel mounting frame 8. The Cessna 182 mount angle 10 functions to accommodate the architecture of the Cessna 182 instrument panel, allowing for the aircraft cockpit tablet mount to fit snugly into a Cessna 182 instrument panel.

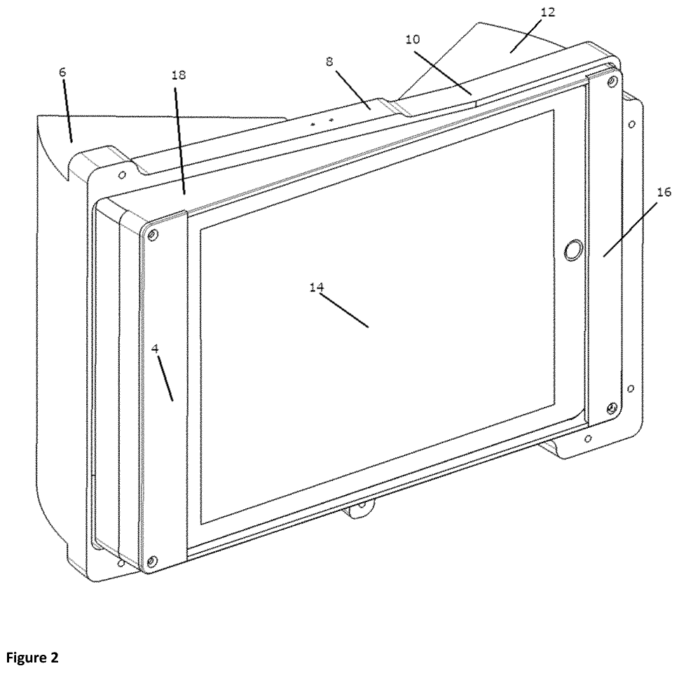

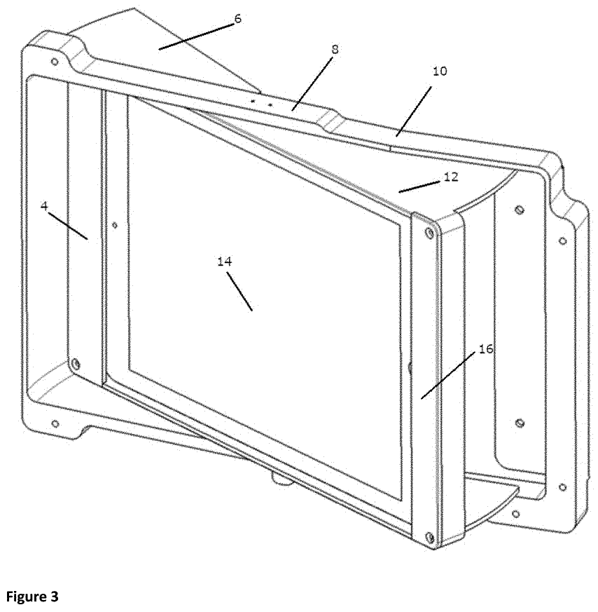

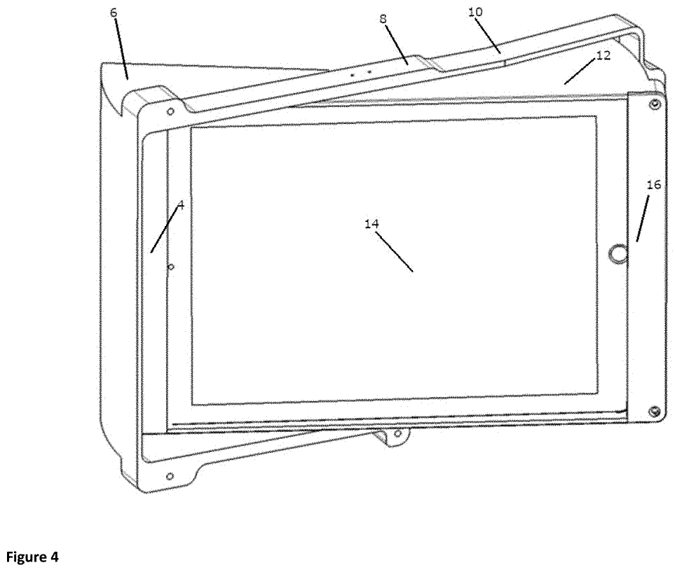

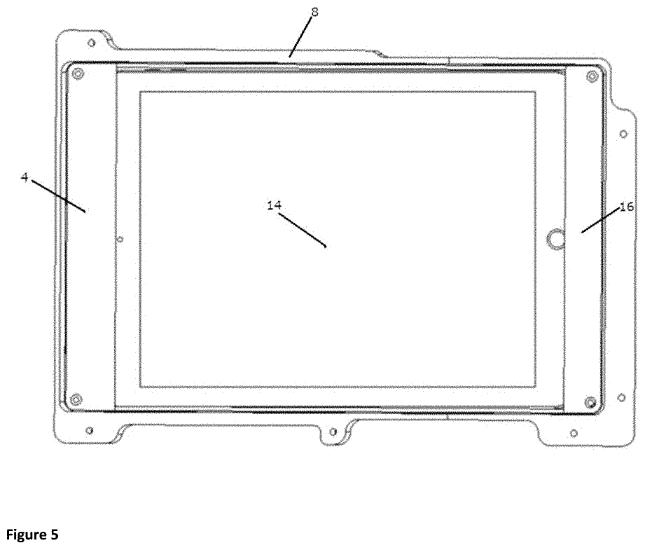

FIGS. 1, 2, and 5 show a front view of the aircraft cockpit tablet mount in its closed state, where said tablet mounting frame 18 faces the rear of the aircraft. FIGS. 3 and 4 show a front view of the aircraft cockpit tablet mount in its open state, where said tablet mounting frame 18 is angled toward the operator of the aircraft.

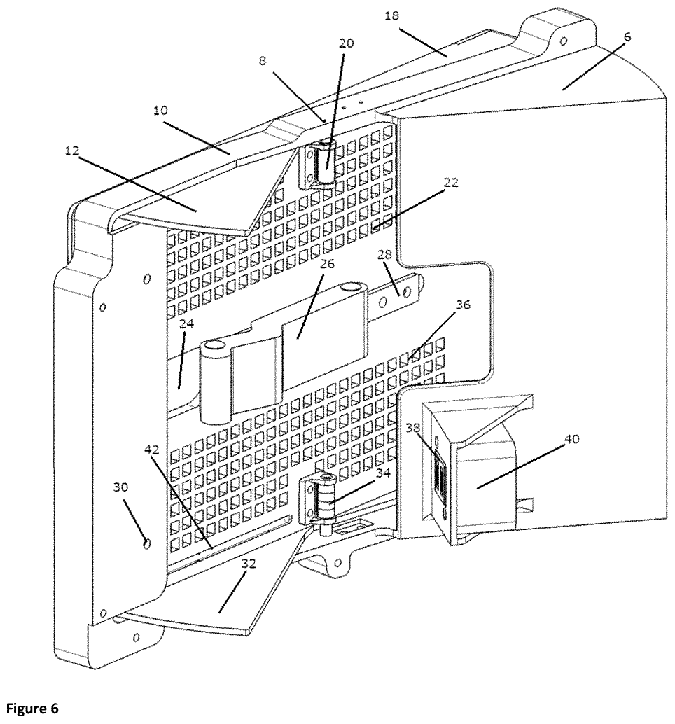

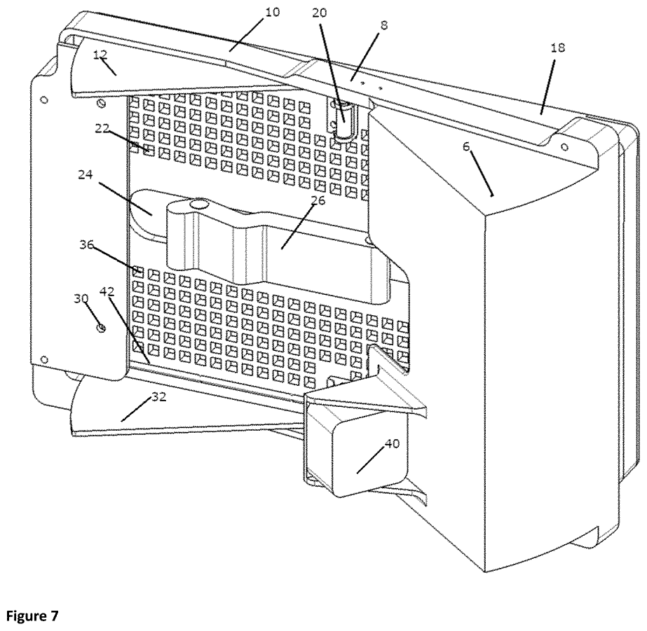

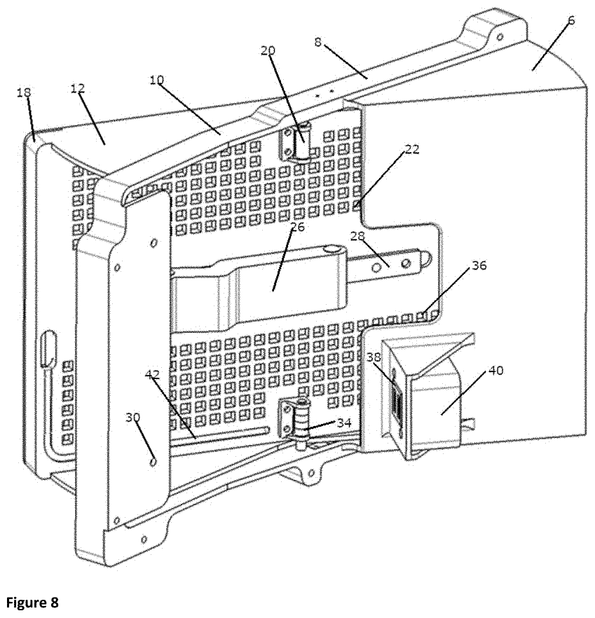

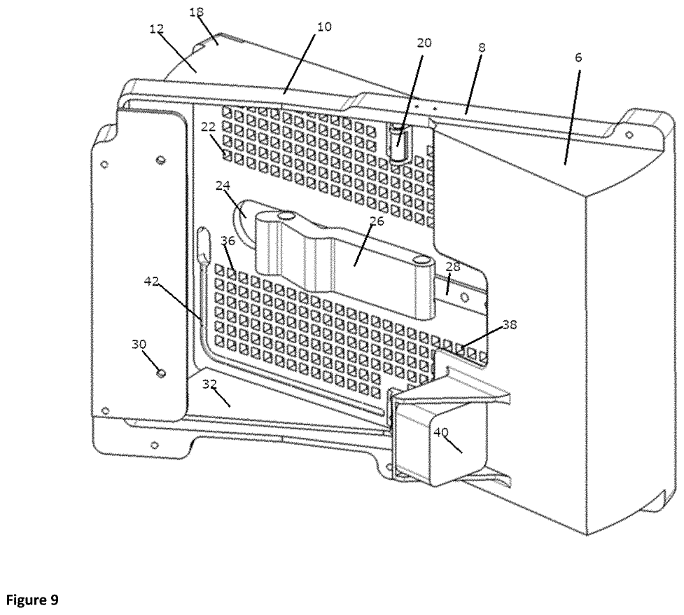

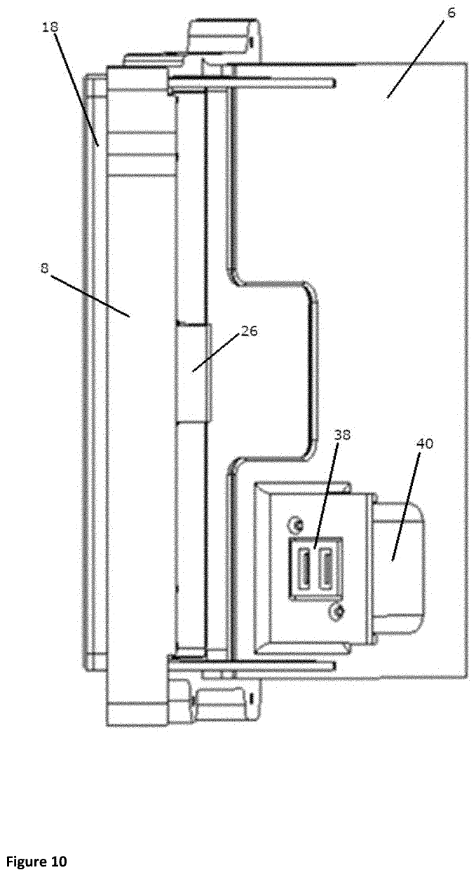

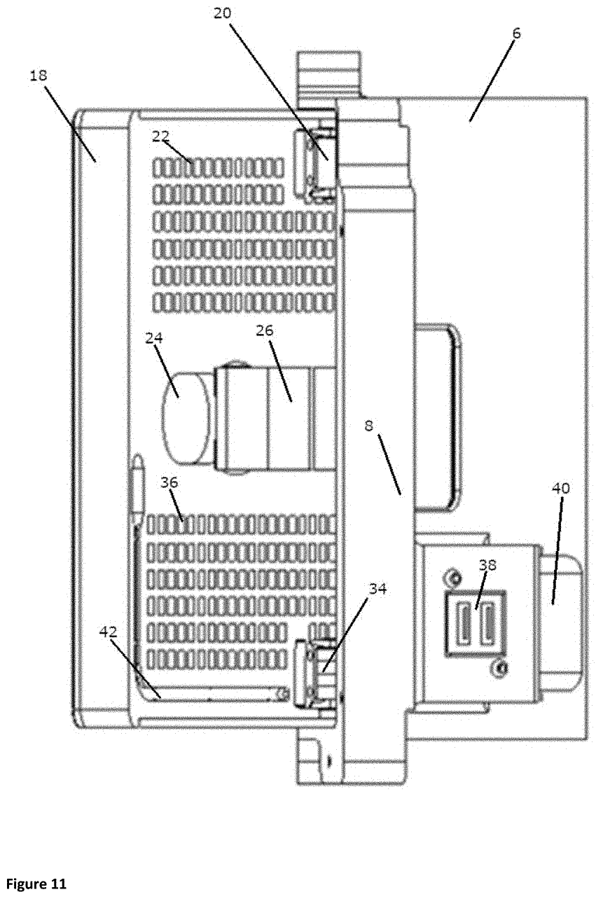

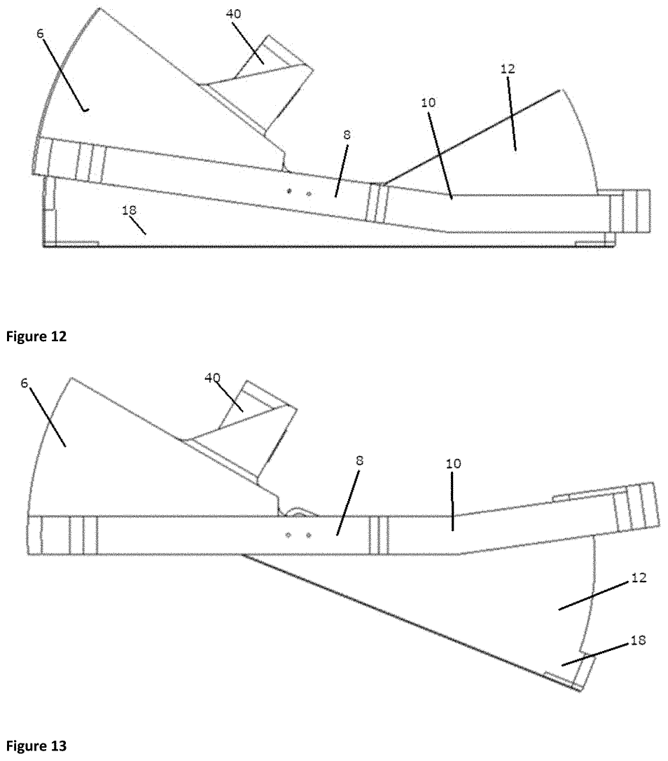

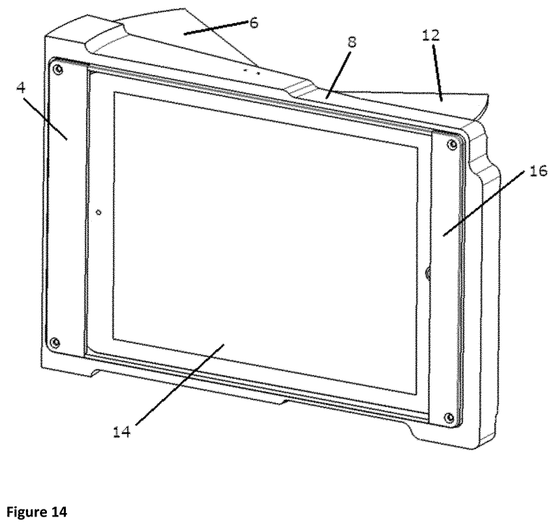

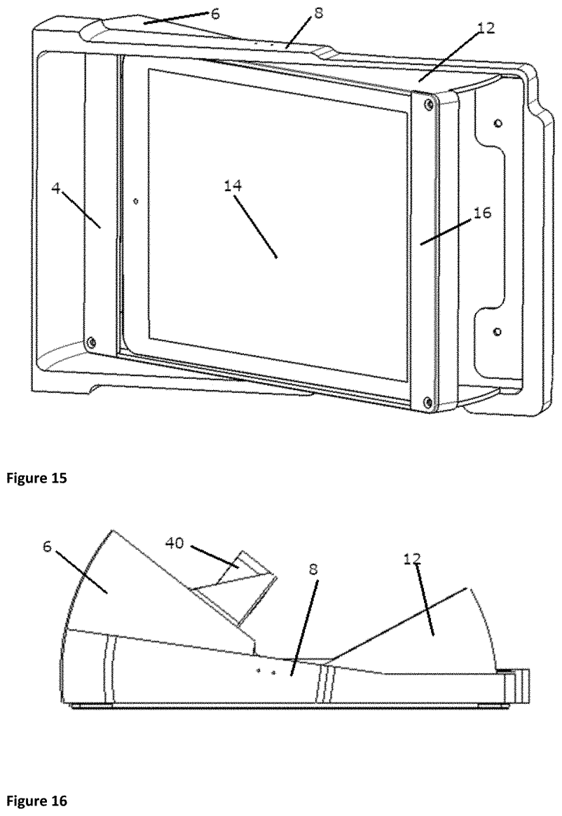

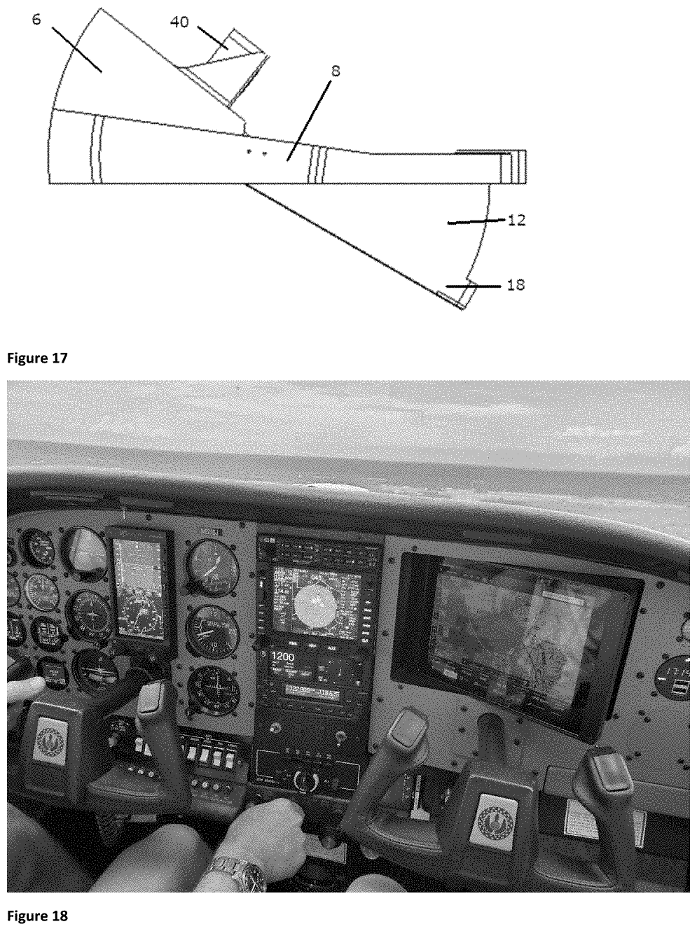

FIGS. 6, 7, 8, and 9 show the rear of an embodiment of the aircraft cockpit tablet mount. The rear of said tablet mounting frame 18 comprises an upper infinite angle torque hinge 20 and a lower infinite angle torque hinge 34, which are located medially on the top and bottom of the rear of said tablet mounting frame 18 respectively. Said upper infinite angle torque hinge 20 and lower infinite angle torque hinge 34 are attached to said tablet mounting frame 18 and said panel mounting frame 8, which allows for the rotation of said tablet mounting frame 18.

Said tablet mounting frame 18 further comprises upper tablet ventilation openings 22, which are located toward the top of the rear of said tablet mounting frame 18. Said tablet mounting frame also comprises lower tablet ventilation openings 36, which are located toward the bottom of the rear of said tablet mounting frame 18. Said upper tablet ventilation openings 22 and said lower tablet ventilation openings 36 function to provide greater airflow to the tablet housed inside said tablet mounting frame 18. Said tablet mounting frame 18 further comprises a tablet charging cord channel 42, which is located below said lower tablet ventilation openings 36.

Said tablet mounting frame 18 further comprises positive over-center latching 26 and latch keeper 28, which are both located near the center of the rear of said tablet mounting frame 18 and function to positively hold a tablet in place. Located to the left (when viewed from the rear) of said positive over-center latching 26 is tablet removal port 24. Said tablet removal port 24 functions to allow the user to more easily remove a tablet from said tablet mounting frame 18.

Said panel mounting frame 8 further comprises a USB port housing 40, which is attached to the lower rear end of said rear housing 6. Said USB port housing 40 contains a set of USB ports 38. Said USB ports 38 may be used to provide power for a tablet housed in said tablet mounting frame 18. Said panel mounting frame further comprises a bumper insert 30, where a rubber or other similar bumper may be inserted.

FIG. 14 illustrates an alternative (flat instrument panel) embodiment of the invention which lacks said Cessna 182 Mount Angle 10. The embodiment referred to in FIG. 14 is identified generally by the reference number 44.

What is claimed is:

1. An apparatus for mounting a tablet computer to a surface of an instrument panel in the cockpit of an airplane comprising:
(A) a tablet computer holding member wherein the tablet computer holding member configured for securely and reversibly fastened the tablet computer into the member and the tablet computer holding member comprises a back and a connection means for connecting the tablet computer holding member and an instrument panel mounting member;
(B) the instrument panel mounting member wherein the instrument panel mounting member comprises a fastening means for fastening the mounting member onto a surface of an instrument panel and is configured for mounted such that the front of the apparatus is flush against the surface of the instrument panel and wherein the instrument panel mounting member has wing on the left and right side of the apparatus;
(C) an instrument panel receiving member such that the receiving member is located on the panel of the airplane such that the instrument panel mounting member and the instrument panel receiving member securely fasten the tablet computer holding member to airplane panel;
wherein the tablet computer holding member is secured to a cockpit mounting member at the top and bottom of the long side of the tablet computer holding member equal distance between the left and right side of the tablet computer holding member with a rotating fastener such that the tablet computer holding member rotates within the cockpit mounting member and the cockpit mounting member contains two wings to allow the rotation of the tablet computer holding member to an angle of approximately 30 degrees.

2. The apparatus of claim 1, wherein the tablet computer holding member further comprises a front plate on the left and right side of the tablet computer holding member.

3. The apparatus of claim 1, wherein the means for fastening the member comprises a location for the fasteners on at least four fastener means.

4. The apparatus of claim 3, wherein the apparatus comprises at least six fastener means.

5. The apparatus of claim 1, wherein the back of the tablet computer holding member comprises a venting area.

6. The apparatus of claim 5, wherein the back of the tablet computer holding member comprises two venting areas.

7. The apparatus of claim 1, wherein the instrument panel mounting member further comprises a USB connection port.

8. The apparatus of claim 7, wherein the instrument panel mounting member comprises two USB connection ports.

9. The apparatus of claim 1, wherein the tablet computer holding member comprises a latch for securing the tablet computer into the tablet computer holding member.

10. The apparatus of claim 1, wherein the tablet computer holding member comprises an opening in the back of the tablet computer holding member.

11. The apparatus of claim 10, wherein the tablet computer holding member comprises two openings in the back of the table computer holding member.

12. The apparatus of claim 10, wherein the latch is located adjacent to the opening in the back of the tablet computer holding member.

13. The apparatus of claim 12, wherein the latch and the opening in the back of the tablet computer holding member is located between the two venting areas.

14. The apparatus of claim 12, wherein the latch is located between the two openings in the back of the tablet computer holding member.

15. The apparatus of claim 1, wherein the instrument panel mounting member further comprises a back.

16. The apparatus of claim 15, wherein the back of the instrument panel mounting member is solid.

17. The apparatus of claim 7, wherein the USB connection port is located perpendicular to the back of the instrument panel mounting member.

18. The apparatus of claim 1, wherein the instrument panel mounting member is securely fastened into the instrument panel receiving member and form a secure connection preventing the movement of the tablet computer mounting member in forward, reverse, upward, or downward direction more than 1 mm.

19. The apparatus of claim 18, wherein instrument panel mounting member produces a flush mounting into the instrument panel receiving member such that the tablet computer mounting member is approximately flush with the instrument panel of the airplane.

20. The apparatus of claim 1, wherein the apparatus further comprises a tablet computer.
